(19) United States
(12) Patent Application Publication
(10) Pub. No.: US 2019/0323694 A1
(43) Pub. Date: Oct. 24, 2019

(54) CONVERTIBLE FLOOR LAMP

(71) Applicants: Ellis McDonald, Park Forest, IL (US); Jason Gulley, Park Forest, IL (US)

(72) Inventors: Ellis McDonald, Park Forest, IL (US); Jason Gulley, Park Forest, IL (US)

(21) Appl. No.: 16/389,421

(22) Filed: Apr. 19, 2019

Related U.S. Application Data
(60) Provisional application No. 62/661,740, filed on Apr. 24, 2018.

(51) Int. Cl. F21V 21/06; F21S 8/08; F21V 21/22

(52) U.S. Cl. CPC F21V 21/06; F21V 21/22; F21S 8/08

(57) ABSTRACT

A convertible floor lamp, including a pole, at least one twist lock circumferentially disposed on at least a portion of the pole to unlock at least a portion of the pole in response to rotating in a first rotating direction, and to lock at least a portion of the pole in response to rotating in a second rotating direction, and a base disposed on the second end of the pole to stabilize the pole on a planar surface.

### CROSS REFERENCE TO RELATED APPLICATION

This application claims the benefit of, and incorporates by reference, U.S. provisional patent application Ser. No. 62/661,740, entitled “Convertible Floor Lamp,” which was filed on Apr. 24, 2018.

### BACKGROUND

### 1. Field

The present general inventive concept relates generally to a lamp, and particularly, to a convertible floor lamp.

### 2. Description of the Related Art

Lamps come in all different types of shapes and sizes. Lamps may be placed on a table, a desk or even mounted on the wall. Further many lamps come in sufficient size to be placed on the floor. The floor sized lamps may be used in various applications as desired by the user. A typical lamp includes a lampshade, some type of supporting column just to support the lamp and lampshade.

Therefore, there is a need for an adjustable lamp as needed for the user.

### SUMMARY

The present general inventive concept provides a convertible floor lamp.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a convertible floor lamp, including a pole, at least one twist lock circumferentially disposed on at least a portion of the pole to unlock at least a portion of the pole in response to rotating in a first rotating direction, and to lock at least a portion of the pole in response to rotating in a second rotating direction, and a base disposed on the second end of the pole to stabilize the pole on a planar surface.

The pole may include at least one extended portion disposed within at least a portion of the pole to at least partially extend a length of the pole in response to moving a first end of the pole in a first direction away from a second end of the pole, and to at least partially reduce the length of the pole in response to moving the first end of the pole in a second direction toward the second end of the pole.

The at least one extended portion may be released in response to unlocking the at least one twist lock, and may be restrained in response to locking the at least one twist lock.

The convertible floor lamp may further include a lampshade disposed on the first end of the pole to cover a light therein.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a lamp in a first position, according to an exemplary embodiment of the present general inventive concept; and

FIG. 2 illustrates the lamp in a second position, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Convertible Floor Lamp 100
Lampshade 20
Twist Lock 22
Extended Portion 24
Pole 25
Base 27

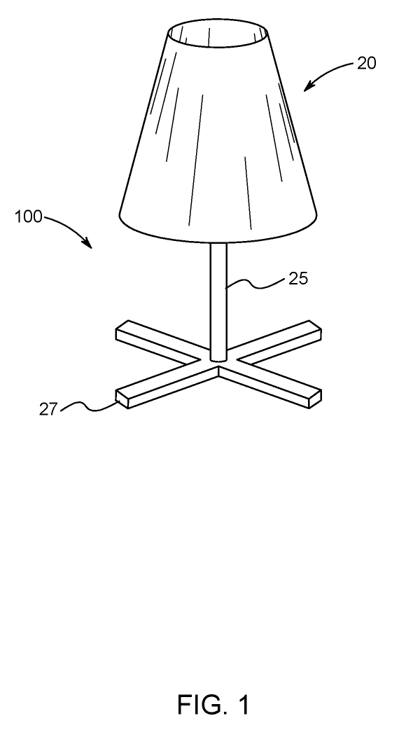

FIG. 1 illustrates a lamp 20 in a first position, according to an exemplary embodiment of the present general inventive concept.

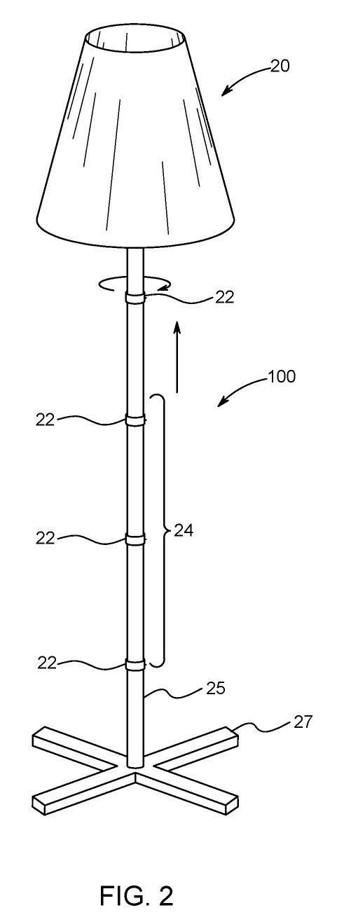

FIG. 2 illustrates the lamp in a second position, according to an exemplary embodiment of the present general inventive concept.

The present general inventive concept relates to the convertible floor lamp 100, which is convertible between a floor lamp and a desk sized lamp by adjusting the pole 25, which is integrated within the convertible floor lamp 100. The convertible floor lamp 100 may include a base 27 and a pole 25 that is adjustable by manipulating at least one twist lock 22 that locks the convertible floor lamp 100 in two positions available.

FIG. 1 illustrates the convertible floor lamp 100 in a first position. In this first position, the convertible floor lamp 100 is configured for desktop or tabletop use. The convertible floor lamp 100 may further include a base 27, where the base 27 includes four equally spaced legs. These legs spread out in a cross type manner as the pole 25 extends vertically from a center of this base 27. The pole 25 supports the convertible floor lamp 100 and a lampshade 20 as shown in FIG. 1.

In reference to FIG. 2, the convertible floor lamp 100 is shown in a second position. In this second position, the pole 25 extends vertically to provide a floor mounted lamp 100 as depicted in FIG. 2. The ability to extend the pole 25 is through the extended portion 24 shown in FIG. 2. Further, the at least one twist lock 22 is also shown that allows the unlocking of the extended portion 24 of the pole 25. This extended portion 24 is locked into place in an extended position in FIG. 2 and may be released by turning the at least one twist lock 22 to return to a table height that is shown in FIG. 1. As a result, the present invention provides a lamp configuration that is convertible between two distinct lamps.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A convertible floor lamp, comprising:
a pole;
at least one twist lock circumferentially disposed on at least a portion of the pole to unlock at least a portion of the pole in response to rotating in a first rotating direction, and to lock at least a portion of the pole in response to rotating in a second rotating direction; and
a base disposed on the second end of the pole to stabilize the pole on a planar surface.

2. The convertible floor lamp of claim 1, wherein the pole comprises:
at least one extended portion disposed within at least a portion of the pole to at least partially extend a length of the pole in response to moving a first end of the pole in a first direction away from a second end of the pole, and to at least partially reduce the length of the pole in response to moving the first end of the pole in a second direction toward the second end of the pole.

3. The convertible floor lamp of claim 2, wherein the at least one extended portion is released in response to unlocking the at least one twist lock, and is restrained in response to locking the at least one twist lock.

4. The convertible floor lamp of claim 1, further comprising:
a lampshade disposed on the first end of the pole to cover a light therein.
